(19) United States
(12) Patent Application Publication
(10) Pub. No.: US 2007/0079180 A1
(43) Pub. Date: Apr. 5, 2007

(54) Method and an apparatus for frequency measurement

(75) Inventor: Junichi Miyamoto, Tokyo (JP)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Verigy (Singapore) Pte. Ltd.

(21) Appl. No.: 11/518,463

(22) Filed: Sep. 8, 2006

(30) Foreign Application Priority Data
Sep. 22, 2005 (JP) 2005-276209

(51) Int. Cl. G11B 20/20; G06K 5/04; G11B 5/00

(52) U.S. Cl. 714/700

(57) ABSTRACT

The frequency of the signal under test is measured by measuring the time of a prescribed phase of the signal under test, and calculating the slope of the approximate line related to above-mentioned prescribed phase and the above-mentioned measured time or the reciprocal of the above-mentioned slope as the above-mentioned frequency.

### FIELD OF THE INVENTION

The present invention relates to a technique for measuring the frequency of a signal under test.

### DISCUSSION OF THE BACKGROUND ART

Conventionally, the frequency of a signal under test, for example, is obtained by determining the period of an analog-to-digital converted signal under test and measuring the frequency (i.e., refer to Unexamined Japanese Patent Application No. H5-340975 (p. 2, FIG. 12)), or calculations based on the number of times the signal under test crosses a reference level within a prescribed time and the prescribed time (i.e., refer to Unexamined Japanese Patent Application No. H2000-65874 (pp. 2-3, FIG. 3), or taking the Fourier transform of the signal under test (i.e., refer to Unexamined Japanese Patent Application No. H10-213613 (p. 2)).

A method for calculating the frequency from the number of crossings and a prescribed time requires an extremely large number of sampling points in order to improve the measurement resolution. For example, in the simplest case, at least 1,000,000 sampling points are needed in order to achieve a 1 ppm measurement accuracy. In addition, a method that takes the Fourier transform of the signal under test requires a large number of sampling points and a long measurement time when a wideband signal under test is analyzed. This method can reduce the number of sampling points and the measurement time by estimating the frequency of the signal under test by an interpolation method from each frequency component of the Fourier transform result. However, when a signal under test having a duty ratio substantially different from 50% such as 10% or 90% is measured, meaningless measurements are obtained because of corruption by aliasing, and a high-speed sampling, a huge number of sampling points, as well as a long measurement time are needed to avoid this problem. Therefore, the object of the present invention is to provide a method or an apparatus that measures the frequency of a signal under test in a shorter time than conventionally and is stable regardless of the magnitude of the duty ratio.

### SUMMARY OF THE INVENTION

The present invention provides the following method and apparatus for solving the above problems. Specifically, a method for measuring the frequency of a signal under test and comprises a first step for measuring the time of a prescribed phase of the signal under test and a second step for calculating the slope of an approximate line related to the above-mentioned prescribed phase and the above-mentioned measured time or the reciprocal of the above-mentioned slope.

The above-mentioned first step comprises a step for comparing the above-mentioned signal under test to a reference level and a step for measuring the time of the prescribed phase of the above-mentioned comparison result as the time of the prescribed phase of the above-mentioned signal under test.

Further, the first step may, optionally, comprise a step for comparing the above-mentioned signal under test to a reference level, a step for sampling the result of the above-mentioned comparison, and a step for measuring the time of the prescribed phase of the above-mentioned sampling result as the time of the prescribed phase of the above-mentioned signal under test.

Further, the first step may comprise a step for sampling the above-mentioned signal under test, a step for comparing the result of the above-mentioned sampling to a reference level, and a step for measuring the time of the prescribed phase of the result of the above-mentioned comparison as the time of the prescribed phase of the above-mentioned signal under test.

Preferably, the second step for estimating the above-mentioned approximate line is by the least squares method.

The present invention also includes an apparatus for measuring the frequency of the signal under test and comprises timer for measuring the time of the prescribed phase of the signal under test and calculator for calculating the slope of the approximate line related to the above-mentioned prescribed phase and the above-mentioned measured time or the reciprocal of the above-mentioned slope as the above-mentioned frequency.

The timer for comparing the above-mentioned signal under test to a reference level and measuring the time of the prescribed phase of the above-mentioned comparison result as the time of the prescribed phase of the above-mentioned signal under test.

Alternatively, the timer for comparing the above-mentioned signal under test to a reference level, sampling the result of the above-mentioned comparison, and measuring the time of the prescribed phase of the above-mentioned sampling result as the time of the prescribed phase of the above-mentioned signal under test.

Further, the timer is capable of sampling the above-mentioned signal under test, comparing the above-mentioned sampling result to the reference level, and measuring the time of the prescribed phase of the above-mentioned comparison result as the time of the prescribed phase of the above-mentioned signal under test.

Further, the calculator for estimating the above-mentioned approximate line by the least squares method.

Preferably, the frequency of a signal under test can be measured with high accuracy by using relatively few sampling points compared to a conventional method because the effect of long-term averaging over a plurality of periods is taken into account by determining the approximate line related to the prescribed phase of the signal under test and the time of the prescribed phase. In addition, according to the present invention, the frequency of the signal under test can be measured stably and accurately while not being affected by the duty ratio because analysis is only on the time axis. Further, according to the present invention, inadequate accuracy in the apparatus used to measure the frequency, for example, a time measuring apparatus, a level comparison apparatus, or a sampling apparatus, can be corrected, and the accuracy and performance required in these apparatuses can be relaxed to achieve the prescribed measurement accuracy.

### BRIEF DESCRIPTION OF THE DRAWINGS

FIG. 1 is a block diagram showing the structure of semiconductor tester 100.

FIG. 2 is a view showing the signal and memory contents in semiconductor tester 100.

FIG. 3 is a scatter plot showing the relationship between the phase and time of signal under test M.

FIG. 4 is a block diagram showing the structure of semiconductor tester 300.

FIG. 5 is a view showing the signal and memory contents in semiconductor tester 300.

FIG. 6 is a scatter plot showing the relationship between the phase and time of signal under test L.

### DETAILED DESCRIPTION OF THE PREFERRED EMBODIMENT

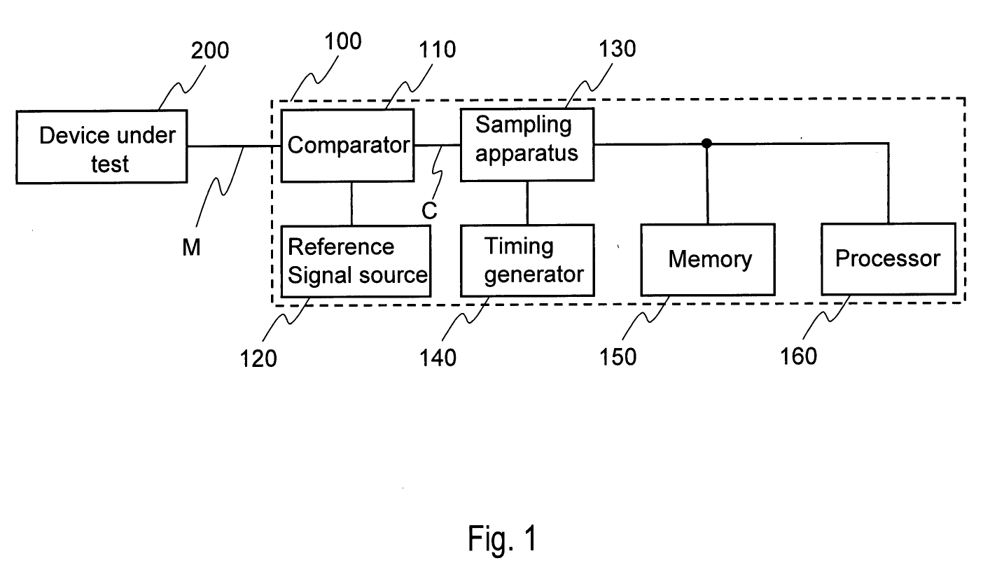

Next, the present invention is explained based on the preferred embodiments shown in the attached drawings. A first embodiment of the present invention is a semiconductor tester that functions as a frequency measurement apparatus. First, the structure of a semiconductor tester 100 of this embodiment is explained. In this case, FIG. 1 is referenced. FIG. 1 is a block diagram illustrating the structure of semiconductor tester 100. Semiconductor tester 100 is connected to a device under test 200. Semiconductor tester 100 comprises a comparator 110, a reference signal source 120, a sampling apparatus (sampler) 130, a timing generator 140, a memory 150, and a processor 160. Comparator 110 is an apparatus for comparing the signal under test M which is the output signal of device under test 200 and the output signal of reference signal source 120. If the amplitude level of signal under test M is larger than the output signal of reference signal source 120, comparator 110 outputs a high logic level (High). If the amplitude level of signal under test M is less than the output signal of reference signal source 120, comparator 110 outputs a low logic level (Low). Sampling apparatus 130 is an apparatus for sampling the output signal C of comparator 110 in response to the timing signal output by timing generator 140. Sampling apparatus 130 is, for example, a flip-flop circuit or a sample-and-hold circuit. Timing generator 140 is an apparatus for generating the signal for notifying the timing at a prescribed time interval. The output signal of timing generator 140 is, for example, a rectangular signal or a sinusoidal signal. Memory 150 is an apparatus for storing each sampling result of sampling apparatus 130, for example, a DRAM, a flash memory, or a hard disk drive. Processor 160 is an apparatus for processing the data stored in memory 150 and calculating the frequency of signal under test M, for example, a calculation processing apparatus such as an MPU or DSP.

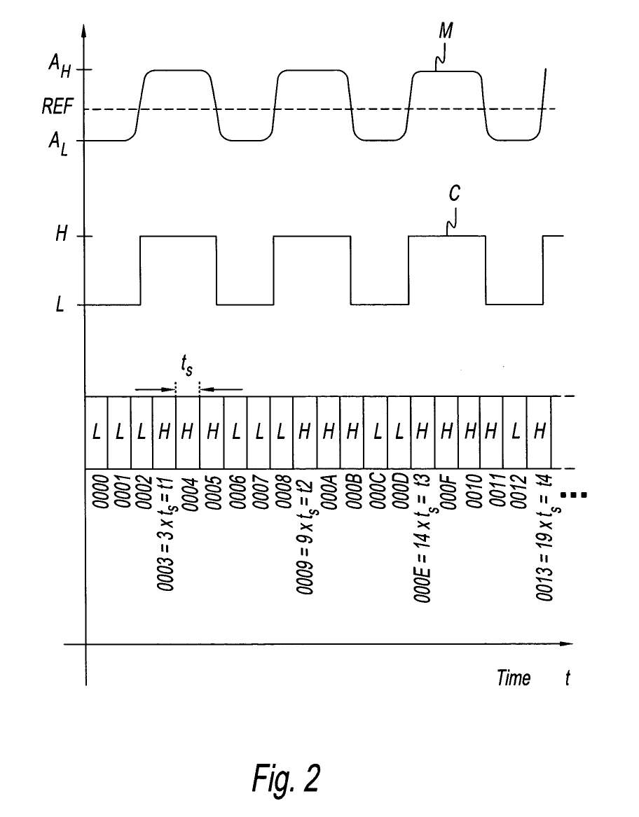

Next, the operation of semiconductor tester 100 is explained. In addition to FIG. 1, FIG. 2 is referenced. The top graph in FIG. 2 shows the signal under test M. The middle graph in FIG. 2 shows an output signal C of comparator 110. The bottom graph in FIG. 2 shows the data stored in memory 150. Signal under test M is a signal having a periodically repeating oscillation between level A_{H} and level A_{L}. The output signal of reference signal source 120 is a DC signal having level A_{REF}. Comparator 110 compares signal under test M to reference level A_{REF}. Comparator 110 outputs a digital signal as the comparison result. Comparator 110 outputs a high logic level if signal under test M is greater than or equal to reference level AREF. On the other hand, comparator 110 outputs a low logic level if signal under test M is less than reference level A_{REF}. Output signal C of comparator 110 indicates the specific phase of the signal under test because signal under test M is a repeating signal. Sampling apparatus 130 samples the output signal (high or low logic level) of comparator 110 at a constant interval. Each sampling result is stored in memory 150 in a time sequence as the data. The data stored in memory 150 are specified by the hexadecimal addresses 0000 to 0013 in the bottom part of FIG. 2 and each is shown in a box having a time width tₛ. Time width tₛ equals the sampling interval of sampling apparatus 130. An address represents the time when the data shown in the related box was sampled. For example, the data stored at address 0003 (high logic level) was sampled at time (3×tₛ).

Then, processor 160 examines the time of the prescribed phase of signal under test M. The details are as follows. Processor 160 first references the data stored in memory 150 and examines each address where the data changed from the low logic level to the high logic level. Next, processor 160 calculates the time corresponding to each address. In FIG. 2, the address of the first transition is 0003. Time width tₛ is multiplied by this address value (3) to calculate the time ti corresponding to the first transition point. Similarly, processor 160 calculates the times corresponding to the other transition points to obtain the times t₂, t₃, and t₄. Times t₁, t₂, t₃, and t₄ are the relative times with the sampling time of the data stored at address 0000 as the reference. Times t₁, t₂, t₃, and t₄ indicate the times of the prescribed phases of the signal represented by the data stored in memory 150 and the period of the signal represented by the data stored in memory 150. For example, when time to is set as the phase reference, the relative phase becomes 2π at time t₂, 4π at time t₃, and 6π at time t₄. In general, the prescribed phase of the signal represented by the data stored in memory 150 can be regarded as the prescribed phase of signal under test M.

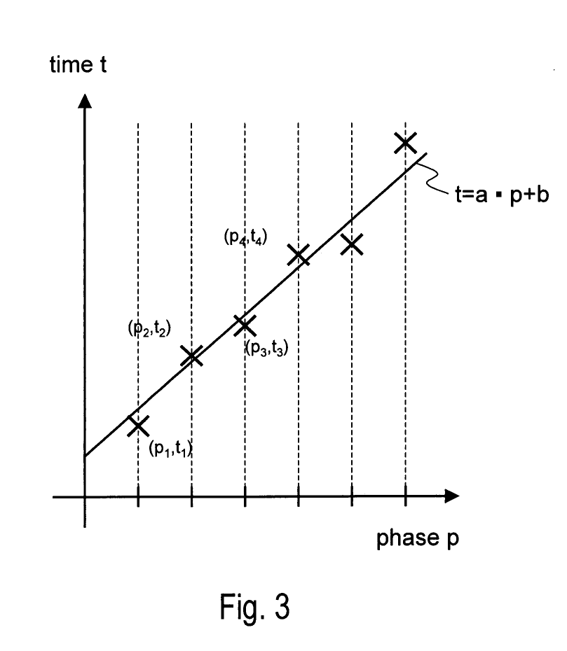

Next, the approximate line related to the prescribed phase and the corresponding time of the signal represented by the data stored in memory 150 is estimated. Here, FIG. 3 is referenced. FIG. 3 is a scatter plot of the prescribed phase of the signal represented by the data stored in memory 150 and the time corresponding to that prescribed phase. The horizontal axis indicates the prescribed phase of the signal represented by the data stored in memory 150. The vertical axis indicates the time corresponding to the prescribed phase of the signal represented by the data stored in memory 150. Each marker indicated by x in the figure shows each transition point of the data stored in memory 150. The coordinate of each marker is given by the relative phase and the relative time. Further, the vertical dashed lines in the figure indicate the period every 2π when phase p₁ was set as the reference. Each marker is plotted on each vertical dashed line. Then the approximate line for the markers in the scatter plot shown in the figure is determined. If the approximate line is expressed as a function of phase p, then t=a·p+b. Alternatively, if the same approximate line is expressed as a function of time t, then p=c·t+d. The approximate line is estimated from the prescribed phase and the corresponding time of the signal represented by the data stored in memory 150 by the least squares method. For example, let the coordinates of a marker be (pᵢ, tᵢ); then coefficient a and coefficient b are determined from the following equations.

$$a = \frac{N \sum {p}_{i} {t}_{i} - \sum {p}_{i} \sum {t}_{i}}{N \sum {p}_{i}^{2} - {( \sum {p}_{i} )}^{2}} \\ b = \frac{N \sum {t}_{i} \sum {p}_{i}^{2} - \sum {p}_{i} \sum {p}_{i} {t}_{i}}{N \sum {p}_{i}^{2} - {( \sum {p}_{i} )}^{2}} \qquad [ Equation 1 ]$$

Coefficient c and coefficient d can be similarly determined. The reciprocal of the slope a of the estimated function and slope c are equivalent to the frequency of signal under test M. Because this embodiment may determine the slope of the approximate line, each axis and coordinate in the figure, that is, the time and phase may either be an absolute value or a relative value.

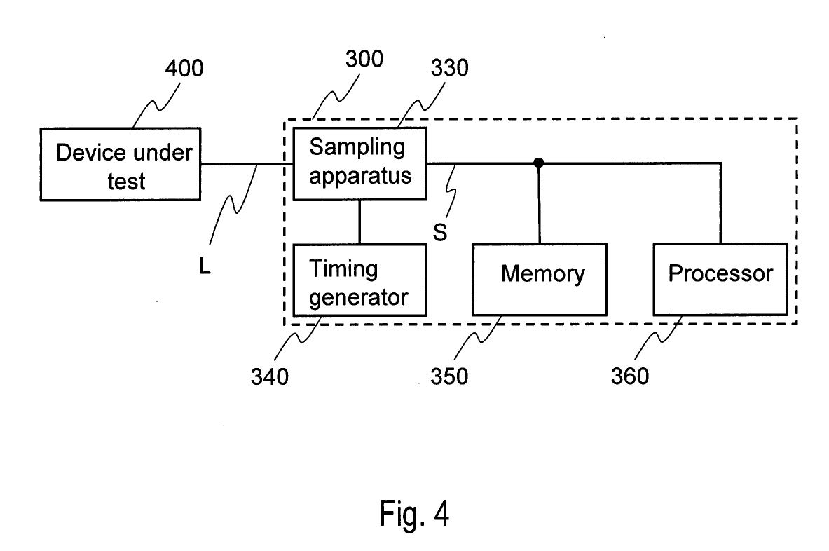

Next, a second embodiment of the present invention is explained. The second embodiment of the present invention is a semiconductor tester that functions as the frequency measuring apparatus. First, the structure of a semiconductor tester 300 is explained. Here, FIG. 4 is referenced. FIG. 4 is a block diagram illustrating the structure of semiconductor tester 300. Semiconductor tester 300 is connected to a device under test 400. Semiconductor tester 300 comprises a sampling apparatus (sampler) 330, a timing generator 340, a memory 350, and a processor 360. Sampling apparatus 330 is an apparatus for sampling signal under test L in response to the timing signal output by timing generator 340, applying analog-to-digital conversion to the sampling result, and outputting the conversion result. Sampling apparatus 330 is, for example, a sample-and-hold circuit or a track-and-hold circuit. Timing generator 340 is an apparatus for generating the signal to indicate the timing with a prescribed time interval. The output signal of the timing generator 340 is, for example, a rectangular signal or a sinusoidal signal. Memory 350 is an apparatus for storing each sampling result of sampling apparatus 330 and is, for example, a DRAM, a flash memory, or a hard disk drive. Processor 360 is an apparatus for processing the data stored in memory 350 and calculating the frequency of signal under test L and is, for example, a calculation processing apparatus such as an MPU or DSP.

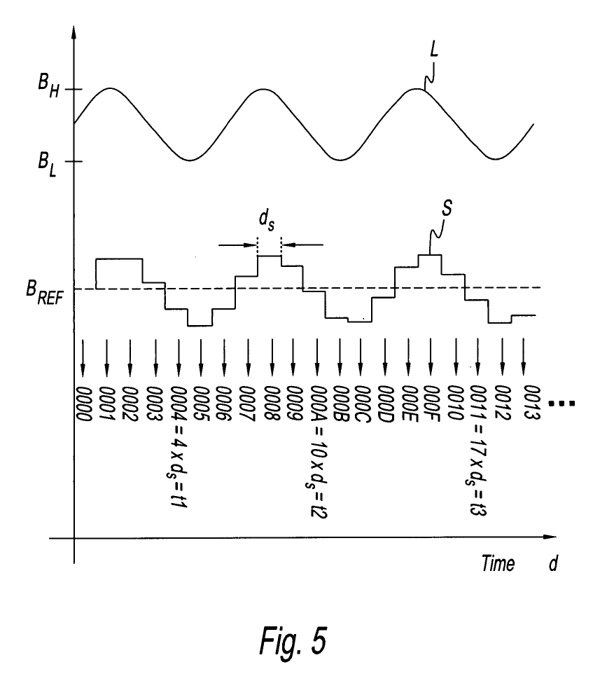

Next, the operation of semiconductor tester 300 is explained. In addition to FIG. 4, FIG. 5 is referenced. The top graph in FIG. 5 illustrates signal under test L. The middle graph in FIG. 5 shows a signal S represented by the sampling results of sampling apparatus 330. Signal under test L is a signal having a periodically repeating oscillation between level B_{H} and level B_{L}. Sampling apparatus 330 samples the signal under test L at a constant interval. Each sampling result is stored in memory 350 in a time sequence as the data after conversion to a digital value. The storage destination of each sampling result is specified by the address shown in the bottom part of FIG. 5. A time width dₛ is the sampling time interval of sampling apparatus 330. The address represents the time when the related data were sampled. For example, the data stored at address 0004 are the data sampled at time (4×dₛ).

Processor 360 examines the time having the prescribed phase of signal under test L. The details are as follows. First, processor 360 references the data stored in memory 350 and examines each address when the data point crosses the reference level B_{REF} from level A_{H} to level A_{L}. Next, processor 360 calculates the time corresponding to each address. In FIG. 5, the address of the first transition point is 0004. The value of this address (4) is multiplied by the sampling time width dₛ to calculate the time d₁ corresponding to the first transition point. Similarly, processor 360 calculates the times corresponding to the other transition points and obtains times d₂ and d₃. Times d₁, d₂, and d₃ are relative times when the reference is the sampling time of the data stored at address 0000. Times d₁, d₂, and d₃ indicate the times at the prescribed phase of the signal represented by the data stored in memory 350 and the periods of the signal represented by the data stored in memory 350. For example, when time d₁ is set as the phase reference, the relative phase becomes 27 at time d₂, 4π at time d₃, and 6π at time d₄. In general, the prescribed phase of the signal represented by the data stored in memory 350 can be regarded as the prescribed phase of signal under test L.

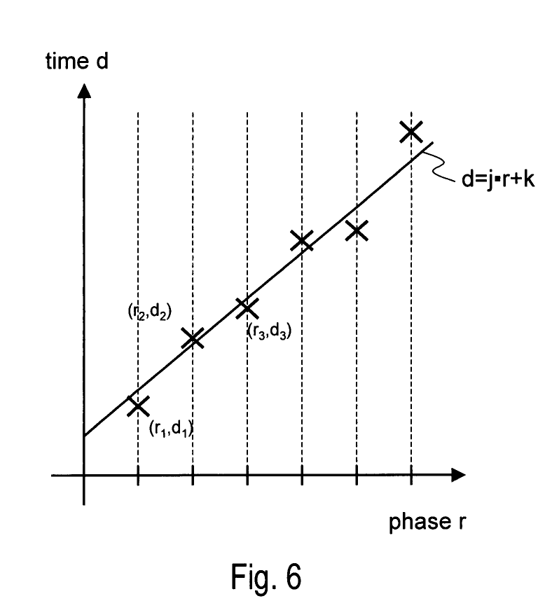

Next, the approximate line of the prescribed phase and the corresponding time of the signal represented by the data stored in memory 350 is estimated. Here, FIG. 6 is referenced. FIG. 6 is a scatter plot of the prescribed phase of the signal represented by the data stored in memory 350 and the time corresponding to that prescribed phase. The horizontal axis indicates the prescribed phase of the signal represented by the data stored in memory 350. The vertical axis indicates the time corresponding to the prescribed phase of the signal represented by the data stored in memory 350. Similar to the above, each marker indicated by x in the figure shows each point crossing the reference level of the data stored in memory 350. The coordinate of each marker is given by the relative phase and the relative time. Further, the vertical dashed lines in the figure indicate the period every 2π when phase r, was set as the reference. Each marker is plotted on each vertical dashed line. Then the approximate line for the markers in the scatter plot shown in FIG. 6 is determined. If the approximate line is expressed as a function of phase r, then d=j·r+k. Alternatively, if the same approximate line is expressed as a function of time d, then r=u·d+v. The approximate line is estimated from the prescribed phase and the corresponding time of the signal represented by the data stored in memory 350 by the least squares method. For example, let the coordinates of a marker be (rᵢ, dᵢ); then coefficient r and coefficient d are determined from the following equations.

$$j = \frac{N \sum {r}_{i} {d}_{i} - \sum {r}_{i} \sum {d}_{i}}{N \sum {r}_{i}^{2} - {( \sum {r}_{i} )}^{2}} \\ k = \frac{N \sum {d}_{i} \sum {r}_{i}^{2} - \sum {r}_{i} \sum {r}_{i} {d}_{i}}{N \sum {r}_{i}^{2} - {( \sum {r}_{i} )}^{2}} \qquad [ Equation 2 ]$$

Coefficient u and coefficient v can be similarly determined. Then the reciprocal of the slope r of the estimated function and slope u are equivalent to the frequency of signal under test L. Because the slope of the approximate line may be determined in this embodiment, each axis and coordinate value in the figure, that is, the time and phase can be either an absolute value or a relative value.

### WORKING EXAMPLE 1

Next, the effects of the present invention are illustrated. Here, Table 1 is referenced. Table 1 compares conventional techniques to the present invention. Table 1 shows the measurement times needed by each conventional technique and the present invention when the frequency was measured with the same accuracy. Conventional technique (1) is a method for determining the period of the analog-to-digital converted signal under test and calculating the frequency. Conventional technique (2) is a method for calculating the frequency by the FFT and an interpolation method. The present invention is the method explained in the first embodiment. The shared measurement conditions are a frequency of 18.75 kHz of signal under test M and a measurement accuracy of 0.1875 Hz (10 ppm). The measurement conditions for the present invention are a sampling rate of 0.48M samples/second and 600 sampling points. Further, the measurement conditions for conventional technique (1) are a sampling rate of 9.6M samples/second and 11,300 sampling points. Further, the measurement conditions for conventional technique (2) are a sampling rate of 0.075M samples/second and 256 sampling points. Because conventional technique (1) obtains a plurality of periods, they are added and averaged, and the reciprocal of the average period is calculated as the frequency of signal under test M.

TABLE 1

| | Measurement time | | | | | |
|---|---|---|---|---|---|---|
| Frequency | (milliseconds) | | | | | |
| measurement | DR = | DR = | DR = | Fs (samples/ | N | |
| method | 50% | 10% | 90% | second) | (points) | Error |
| The present | 1.3 | 1.3 | 1.3 | 0.48 M | 600 | 0.03 Hz |
| invention | | | | | | |
| Conventional | 11.8 | 11.8 | 11.8 | 9.6 M | 11,300 | 0.183 Hz |
| technique (1) | | | | | | |
| Conventional | 3.4 | * | * | 0.075 M | 256 | 0.003 Hz |
| technique (2) | | | | | | |

Table 1 lists each measurement time when the duty ratio (DR in the table) is 50%, 10%, and 90%. For example, according to the present invention, for the duty ratio of 50%, 1.3 milliseconds is needed as the measurement time. In conventional technique (2), the asterisk (*) mark in the measurement time column means that the measurement was not possible. As explained earlier, the reason is that meaningless measurements are obtained because of corruption by aliasing when a signal under test having a duty ratio at 10% or 90%, which is substantially different from 50%, is measured. As shown in Table 1, according to the present invention, unrelated to the magnitude of the duty ratio, the frequency of the signal under test can be measured in a shorter time than in the conventional techniques. In addition, according to the present invention, the frequency of a stable signal under test can be measured unrelated to the magnitude of the duty ratio.

In the first embodiment and second embodiment described above, the following modifications are possible. First, a least squares approximation is adopted as the estimation method of the approximate line, but another linear regression method can be applied. For example, the approximate line can be estimated by principal component analysis.

In the first embodiment, to measure the frequency of signal under test M, the rising edge (transition point of the logic level) is used, but the falling edge can be used, or both edges can be used. Similarly, in the second embodiment, to measure the frequency of signal under test L, the intersecting point when falling (point where signal S crosses the reference level) is used, but the intersecting point when rising can be used, or both intersecting points can be used. In short, if the phase satisfying some constant condition and the corresponding time can be known, similar modifications are possible.

Further, in the first embodiment, the time of each edge of the output signal C is measured by memory 150 and processor 160. Instead, each time can be measured by a time measuring apparatus such as a time interval analyzer. In this case, the time of each edge of the output signal C is analyzed in the above-mentioned time measuring apparatus, and the approximate line is estimated by processor 160 based on the analyzed time.

Further, in the first embodiment and the second embodiment, the memory and processor can be separately provided as a computer or a work station.

The present invention can be applied to the frequency measurement of a modulated signal as well as a repeating signal. When a modulated signal is measured by the present invention, the center frequency of the modulated signal can be measured.

What is claimed is:

1. A method for measuring the frequency of a signal under test, said method comprising:
measuring a time of a prescribed phase of said signal under test; and
calculating a slope of an approximate line related to said prescribed phase and said measured time or the reciprocal of said slope as said frequency.

2. The method of claim 1, wherein said measuring step comprises:
comparing said signal under test to a reference level; and
measuring the time of said prescribed phase of said comparison result as the time of said prescribed phase of said signal under test.

3. The method of claim 1, wherein said measuring step comprises:
comparing said signal under test to a reference level;
sampling the result of said comparison; and
measuring said time of said prescribed phase of said sampling result as the time of said prescribed phase of said signal under test.

4. The method of claim 1, wherein said measuring step comprises:
sampling said signal under test;
comparing the result of said sampling to a reference level; and
measuring said time of said prescribed phase of said comparison result as the time of said prescribed phase of said signal under test.

5. The method of claim 1, wherein said calculating step estimates said approximate line by the least squares method.

6. An apparatus for measuring the frequency of the signal under test, said apparatus comprising:
a timer that measures the time of a prescribed phase of said signal under test; and
calculator that calculates a slope of an approximate line related to said prescribed phase and said measured time or a reciprocal of said slope as said frequency.

7. The apparatus of claim 6, wherein said timer compares said signal under test to a reference level and measures the time of said prescribed phase of said comparison result as the time of said prescribed phase of said signal under test.

8. The apparatus of claim 6, wherein said timer compares said signal under test to a reference level, samples the result of said comparison, and measures the time of said prescribed phase of said sampling result as the time of said prescribed phase of said signal under test.

9. The apparatus of claim 6, wherein said timer samples said signal under test, compares said sampling result to a reference level, and measures the time of said prescribed phase of said comparison result as the time of said prescribed phase of said signal under test.

10. The apparatus of claim 6, wherein said calculator estimates said approximate line by the least squares method.
